(19) United States
(12) Patent Application Publication
(10) Pub. No.: US 2013/0287291 A1
(43) Pub. Date: Oct. 31, 2013

(54) METHOD OF PROCESSING DISPARITY SPACE IMAGE

(71) Applicant: ELECTRONICS AND TELECOMMUNICATIONS RESEARCH INSTITUTE, Daejeon-city (KR)

(72) Inventor: Seong-Ik CHO, Daejeon (KR)

(73) Assignee: Electronics and Telecommunications Research Institute, Daejeon-city (KR)

(21) Appl. No.: 13/708,854

(22) Filed: Dec. 7, 2012

(30) Foreign Application Priority Data
Apr. 26, 2012 (KR) 10-2012-0043845

(51) Int. Cl. G06K 9/46; G06K 9/62

(52) U.S. Cl. CPC G06K 9/46; G06K 9/6201
USPC 382/154

(57) ABSTRACT

The present invention relates to a processing method that emphasizes neighboring information around a disparity surface included in a source disparity space image by means of processing that emphasizes similarity at true matching points using inherent geometric information, that is, coherence and symmetry. The method of processing the disparity space image includes capturing stereo images satisfying epipolar geometry constraints using at least two cameras having parallax, generating pixels of a 3D disparity space image based on the captured images, reducing dispersion of luminance distribution of the disparity space image while keeping information included in the disparity space image, generating a symmetry-enhanced disparity space image by performing processing for emphasizing similarities of pixels arranged at reflective symmetric locations along a disparity-changing direction in the disparity space image, and extracting a disparity surface by connecting at least three matching points in the symmetry-enhanced disparity space image.

### CROSS REFERENCE TO RELATED APPLICATION

This application claims the benefit of Korean Patent Application No. 10-2012-0043845, filed on Apr. 26, 2012, which is hereby incorporated by reference in its entirety into this application.

### BACKGROUND OF THE INVENTION

1. Technical Field

The present invention relates generally to a method of processing a disparity space image. More particularly, the present invention relates to a processing method that provides the step of configuring a disparity space using at least two stereo images and improves similarity between true symmetrical points using geometric information included in the disparity space, that is, coherence and symmetry.

2. Description of the Related Art

Stereo matching denotes a series of processing procedures for, when a target object is captured using two cameras located on left and right sides and two stereo images are created based on the results of capturing, recovering the depth information of the target object using the two stereo images in the reverse order of the above creation procedures. Here, the depth information of the target object is represented by parallax in observation performed by the two cameras, and such parallax is recorded as disparity information indicative of variations in the location of pixels during the procedure of creating stereo images. That is, stereo matching is configured to recover three-dimensional (3D) information about an object using the procedure of calculating disparity information included in the two stereo images. Here, when the two stereo images are arranged to satisfy epipolar geometry constraints, the disparity information corresponds to variations in the left and right locations in the same scan line of the two stereo images. A disparity space is configured based on all pixels of left and right images with respect to each scan line in two stereo images satisfying the epipolar geometry constraints. The geometric shapes of configuration of a 3D disparity space configured using two stereo images can be classified into three types, that is, a classical type (R. D. Henkel, 1997, “Fast stereovision by coherence detection”, Computer Analysis of Images and Patterns, LNCS Vol. 1296), a diagonal type (D. Marr, T. Poggio, 1976, “Cooperative computation of stereo disparity”, Science, Vol. 194, No. 4262), and a slanted type (A. F. Bobick and S. S. Intille, 1999, “Large occlusion stereo,” International Journal of Computer Vision, Vol. 33). The geometric shapes of configuration of the 3D disparity space are different from one another, but pieces of information included in individual pixels of 3D disparity spaces are identical for the respective shapes. The reason for this is that when a diagonal disparity space is rotated at an angle of 45°, a classical disparity space is formed, and when one axis of the diagonal disparity space is slanted at an angle of 45°, a slanted disparity space is formed. However, when the classical disparity space is configured, an interpolation procedure is required for omitted pixels. When images obtained from three or more cameras are used, a generalized disparity space (the configuration of a disparity space disclosed in a paper by R. S. Szeliski and P. Golland, 1997, “Method for performing stereo matching to recover depths, colors and opacities of surface elements”, PCT Application Number US98-07297 (WO98/047097, Filed Apr. 10, 1998), and U.S. Pat. No. 5,917,937, Filed Apr. 15, 1997, Issued Jun. 29, 1999. corresponds to the generalized disparity space) can be configured. Even in the generalized disparity space, one pixel of a generalized disparity space is configured based on individual pixels included in three or more stereo images that satisfy epipolar geometry constraints.

Pixels constituting a disparity space or a generalized disparity space are configured using the luminance information or feature information of pixels included in at least two stereo images. When a disparity space is configured using at least two stereo images, the location of one pixel included in each stereo image corresponds to the location of one pixel in the disparity space or a generalized disparity space. That is, at least one pixel in a corresponding stereo image matches one pixel of the disparity space or the generalized disparity space.

In this case, the value of one pixel in the disparity space can be generated using the values of at least two pixels present in stereo images corresponding to the pixel. The value of one pixel in the disparity space can be generated using an absolute difference between the values of pixels present in the corresponding stereo images, a squared difference between the values of the pixels, an absolute difference to the mean value of a plurality of pixel values, or the like. Further, the value of one pixel in the disparity space can be generated using the sum of absolute differences, the sum of squared differences, cross correlation, or the sum of absolute differences to the mean value of a plurality of pixels, by using the neighboring pixels of the pixels present in stereo images corresponding to the one pixel together with the corresponding pixels. Further, the value of one pixel can also be generated using a similarity computation method obtained by applying an adaptive support weight (K. J. Yoon, I. S. Kweon, 2006, “Adaptive Support-Weight Approach for Correspondence Search”, IEEE Trans. Pattern Analysis and Machine Intelligence, Vol. 28, No. 4). Furthermore, the value of one pixel can also be generated by a similarity computation method using a histogram, which is a method of using only the statistical characteristics of the luminance information of a specific pixel and its neighboring pixels (V. V. Strelkov, 2008, “A new similarity measure for histogram comparison and its application in time series analysis”, Pattern Recognition Letter, Vol. 29).

The value of each pixel in the disparity space can also be generated using feature information, such as edges or gradients, rather than the original values of pixels present in stereo images corresponding to the pixel. Furthermore, the value of each pixel can also be generated using a similarity computation method based on a feature histogram that utilizes only the statistical characteristics of feature information.

Since methods of obtaining the value of one pixel in the disparity space can also be applied to the generalized disparity space, the value of one pixel in the generalized disparity space can be calculated using the values of pixels present in three or more images corresponding to the one pixel.

When points having the highest similarity between stereo images corresponding to the one pixel in the disparity space are found and connected, a 2.5-dimensional surface is generated. Here, the 2.5-dimensional surface is also referred to as a disparity surface or a disparity map, and corresponds to the disparity information of an object desired to be obtained by stereo matching. The depth information of the object can be obtained if a camera model is applied to disparity information. The method or step of extracting such depth information is applied even to the generalized disparity space in the same manner (unless a special indication is made in the following description, the term “disparity space”, used in the description of a processing step after the disparity space has been configured, is used as a meaning including “generalized disparity space”).

A disparity surface corresponding to a curved surface having the highest global similarity in a disparity space is identical to a single curved surface on which a global cost function is minimized, or a single curved surface which has a meaning equivalent thereto and on which a global similarity measurement function is maximized. Such a disparity surface can be obtained using global optimization such as graph-cut optimization, or local optimization such as winner-takes-all-optimization.

When, in the disparity space, the similarity between true matching points (or true targets) based on stereo images corresponding to the disparity space can be set to always be higher than the similarity between false matching points (or false targets), a basis for easily solving a stereo matching problem that is the problem of obtaining a true disparity surface corresponding to the globally optimized solution of stereo matching is provided.

In this way, various algorithms for obtaining a locally optimized solution or a globally optimized solution in a disparity space have been proposed. However, in most documents, a disparity space was merely used as a data space for simply storing information, and there is a problem in that preprocessing for relatively increasing the similarity between true matching points through a preprocessing procedure that exploits the geometric characteristics of the disparity space is not desirably performed.

### SUMMARY OF THE INVENTION

Accordingly, the present invention has been made keeping in mind the above problems occurring in the prior art, and an object of the present invention is to provide a method of processing a disparity space image, which provides the step of configuring a disparity space using at least two stereo images, and improves similarity between true symmetrical points using geometric information included in the disparity space, that is, coherence and symmetry.

In accordance with an aspect of the present invention to accomplish the above object, there is provided a method of processing a disparity space image, including capturing stereo images using at least two cameras; generating pixels of a disparity space image based on the stereo images; generating a symmetry-enhanced disparity space image by performing symmetry enhancement processing on the disparity space image; and extracting a disparity surface by connecting at least three matching points in the symmetry-enhanced disparity space image.

Preferably, the method may further include, before the generating the symmetry-enhanced disparity space image, performing coherence enhancement processing on the disparity space image.

Preferably, the performing the coherence enhancement processing may be configured to apply a function of calculating a weighted mean value of neighboring pixels included in a single Euclidean distance preset for one center pixel of the source disparity space image and a weighted mean value of neighboring pixels included in another Euclidean distance and then calculating a difference between the two weighted mean values.

Preferably, the function of calculating the difference between the two weighted mean values may be configured to apply the following Equation (1) to the disparity space image:

$$C ( {u}_{1} , {v}_{1} , {w}_{1} ) = \frac{1}{{N}_{1}} {\int }_{0}^{{r}_{0}} \frac{D ( r )}{( α + {r}^{n} )} d r - \frac{1}{{N}_{2}} {\int }_{0}^{β {r}_{0}} ( {e}^{- {r}^{m}} D ( r ) ) d r \qquad ( 1 )$$

Preferably, the generating the symmetry-enhanced disparity space image may be configured to apply a function of computing similarities between pixels of the disparity space image arranged at reflective symmetric locations along a vertical direction of a w axis about the center pixel of the source disparity space image.

Preferably, the function of computing the similarities between the pixels of the disparity space image may be configured to perform computation at locations corresponding to respective pixels of the disparity space image by applying the following Equation (2) to the source disparity space image:

S_{D}(u₁,v₁,w₁)=∫∫∫_{0,0,0}^{u}^{₀}^{,v}^{₀}^{,w}^{₀}(Dᵤ(u,v,−w)−D_{d}(u,v,w))²dudvdw (2)

Preferably, the generating the symmetry-enhanced disparity space image may be configured to apply a function of computing similarities between pixels of the coherence-enhanced disparity space image arranged at reflective symmetric locations along a vertical direction of a w axis about one center pixel of the coherence-enhanced disparity space image on which the coherence enhancement processing has been completed.

Preferably, the function of computing the similarities between the pixels of the coherence-enhanced disparity space image may be configured to perform computation at locations corresponding to respective pixels of the disparity space image by applying the following Equation (3) to the coherence-enhanced disparity space image on which the coherence enhancement processing has been completed:

S_{c}(u₁,v₁,w₁)=∫∫∫_{0,0,0}^{u}^{₀}^{,v}^{₀}^{,w}^{₀}(Cᵤ(u,v,−w)−C_{d}(u,v,w))²dudvdw (3)

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart showing a method of processing a disparity space image according to an embodiment of the present invention;

FIG. 2 is a diagram showing a disparity space according to an embodiment of the present invention;

FIG. 3 is a diagram showing the u-w plane of a classical disparity space according to an embodiment of the present invention;

FIG. 4 is a diagram showing the u-w plane of a diagonal disparity space according to an embodiment of the present invention;

FIG. 5 is a diagram showing the u-w plane of a slanted disparity space according to an embodiment of the present invention;

FIG. 6 is a diagram showing an example of the u-w plane of a disparity space image according to an embodiment of the present invention;

FIG. 7 is a diagram showing an example of the v-w plane indicated by cutting a classical disparity space image along a direction perpendicular to a u axis according to an embodiment of the present invention;

FIG. 8 is a diagram showing an example of the u-w plane indicated by cutting the classical disparity space image along a direction perpendicular to a v axis according to an embodiment of the present invention;

FIGS. 9 and 10 are diagrams showing the results of performing a coherence enhancement processing step on the planes of FIGS. 7 and 8;

FIG. 11 is a diagram showing a symmetry enhancement processing step according to an embodiment of the present invention;

FIGS. 12 and 13 are diagrams showing the results of performing the symmetry enhancement processing step on the results of FIGS. 9 and 10; and

FIG. 14 is a diagram showing a spatial range in which the symmetry enhancement processing step is performed according to an embodiment of the present invention.

### DESCRIPTION OF THE PREFERRED EMBODIMENTS

The present invention will be described in detail below with reference to the accompanying drawings. In the following description, redundant descriptions and detailed descriptions of known functions and elements that may unnecessarily make the gist of the present invention obscure will be omitted. Embodiments of the present invention are provided to fully describe the present invention to those having ordinary knowledge in the art to which the present invention pertains. Accordingly, in the drawings, the shapes and sizes of elements may be exaggerated for the sake of clearer description.

Hereinafter, a method and apparatus for processing a disparity space image according to an embodiment of the present invention will be described in detail with reference to the attached drawings.

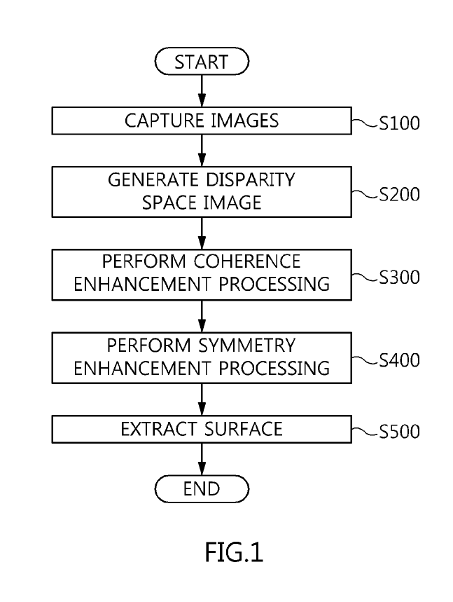

FIG. 1 is a flowchart showing a method of processing a disparity space image according to an embodiment of the present invention.

Referring to FIG. 1, an apparatus for processing a disparity space image (hereinafter also referred to as a “disparity space image processing apparatus”) captures images having parallax using at least two cameras, and outputs the results of capturing as at least two stereo images at step S100.

The disparity space image processing apparatus generates pixels of a three-dimensional (3D) source disparity space image based on the output stereo images at step S200.

The disparity space image processing apparatus generates pixels of a coherence-enhanced disparity space image for emphasizing the coherence of the source disparity space image by applying a local coherence enhancement function to the source disparity space image at step S300.

The disparity space image processing apparatus generates a symmetry-enhanced disparity space image for emphasizing the symmetry of the coherence-enhanced disparity space image by applying a local symmetry enhancement function to the coherence-enhanced disparity space image at step S400.

The disparity space image processing apparatus extracts at least three matching points from the symmetry-enhanced disparity space image, and extracts a disparity surface by connecting the extracted matching points at step S500.

The disparity space image processing apparatus according to the embodiment of the present invention includes the procedure of emphasizing the coherence of the source disparity space image and generating the pixels of the coherence-enhanced disparity space image, but the present invention is not limited thereto. That is, the present invention can obtain a symmetry-enhanced disparity space image for emphasizing the symmetry of the source disparity space image by applying a local symmetry enhancement function to the source disparity space image, without performing the coherence enhancement processing step S300, and can extract a disparity surface by connecting at least three matching points extracted from the symmetry-enhanced disparity space image.

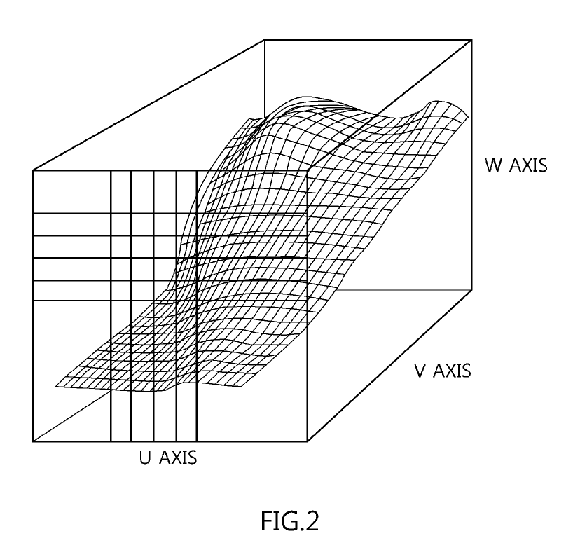

The steps of processing the disparity space image using the above-described disparity space image processing method will be described in detail with reference to FIGS. 2 to 13.

FIG. 2 is a diagram showing a disparity space according to an embodiment of the present invention.

First, stereo images provided as results of capturing in FIG. 1 satisfy epipolar geometry constraints.

At the disparity space image generation step S200 of configuring a disparity space image using two stereo images, if the coordinates of one pixel in a left stereo image are defined as (x_{L}, y) and the coordinates of one pixel in a right stereo image are defined as (x_{R}, y), the coordinates of one pixel in the disparity space are D(u, v, w).

Referring to FIG. 2, the disparity space is a space in which a location is defined by three axes (u axis, v axis, and w axis).

The v axis denotes a direction in which a scan line (u axis) changes, and the w axis denotes a direction in which a disparity value changes.

When epipolar geometry constraints are satisfied, the scan line (u axis) denotes a line arranged at the same location in the left stereo image (hereinafter also referred to as a “left image”) and the right stereo image (hereinafter also referred to as a “right image”). Such a scan line satisfying epipolar geometry is moved to the same location even in the disparity space, so that the y axis coordinates of the stereo image are identical to the v axis coordinates of the disparity space. “u” and “w” corresponding to two different coordinates in the stereo images are respectively represented by relational expressions of x_{L} and x_{R}. Therefore, u and w form a single 2D plane (hereinafter referred to as a “u-w plane”). Similarly to the disparity space, even in a generalized disparity space, a location is defined by three axes (u axis, x axis, and w axis). Even in the generalized disparity space, a u-w plane is formed in a condition satisfying epipolar geometry.

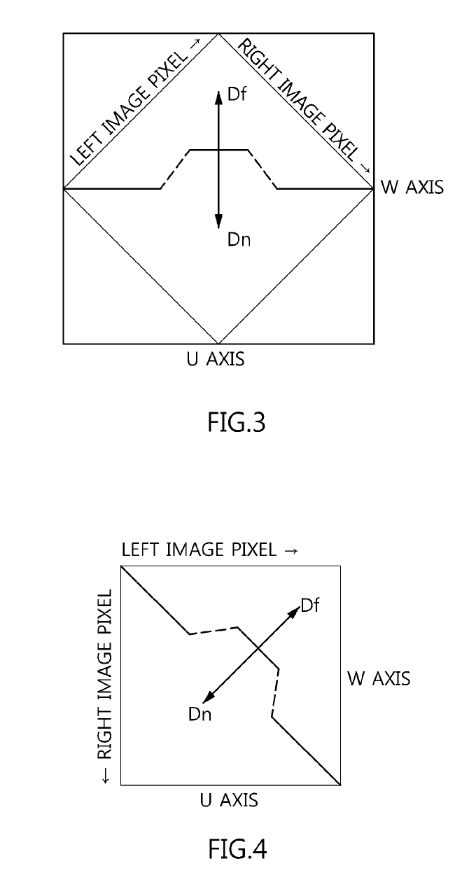

The configuration of the u-w plane corresponds to three types of disparity space configuration, which will be described later in FIGS. 3 to 5. The three types are classical, diagonal, and slanted types.

FIG. 3 is a diagram showing the u-w plane of a classical disparity space according to an embodiment of the present invention.

In the state in which pixels of a left image and pixels of a right image located on the same scan line of stereo images are diagonally arranged, the value of one pixel in the disparity space is configured using a pixel pair of stereo images geometrically corresponding to the pixel. At the disparity space image generation step S200, the pixel value is not necessarily calculated using only a difference between the values of one pixel pair in left and right images. The pixel of the disparity space can be calculated, for pixel pairs present in a predetermined surrounding area in the left and right images, using typical similarity computation means (a similarity measure function or a cost function) used in stereo matching, such as the sum of absolute differences between two image pixel pairs, the sum of squared differences between the two image pixel pairs, cross correlation between the two image pixel pairs, the sum of Hamming distances between the two image pixel pairs, the adaptive support weight of the pixel pairs, a histogram of a set of pixel pairs, the features of the surrounding area, and a histogram of the features. Further, the left image and the right image do not need to always be in initially captured states. The captured images may be, but are not limited to, modified images of source images such as edge-emphasized images, feature-extracted images, census-transformed images, or locally statistically processed images. The typical similarity computation means, and unmodified images that were captured or modified images, are applied even to the disparity space image generation step S200 of calculating the values of pixels of the generalized disparity space.

Since the coordinates of the left image and the right image are diagonally located, there are locations at which the values of pixels cannot be calculated in the classical disparity space. An interpolation operation can be separately performed on such omitted pixels.

Stereo images are 2D planes represented by quantized pixel coordinates having integer values, and the disparity space is a 3D space represented by the quantized pixel coordinates. At the disparity space image generation step S200 of configuring the generalized disparity space, all of the pixel coordinates of stereo images projected into the disparity space do not exactly correspond to the locations of pixels of the disparity space with integer values, so that there are locations where the values of pixels cannot be calculated. In this case, the values of pixels of the generalized disparity space are generated using an interpolation operation.

Referring to FIG. 3, Df denotes a direction in which disparity values are high, and Dn denotes a direction in which disparity values are low. Disparity is present in any one location along the direction of a bidirectional arrow, for one pixel on the u axis.

Horizontal solid lines in the drawing denote lines or surfaces having identical disparity values, and diagonal dotted lines denote a direction in which occlusion is present.

The u-w plane of the classical disparity space is a plane formed by a single scan line. That is, such a disparity space as shown in FIG. 2 can be configured using all scan lines of input stereo images.

FIG. 4 is a diagram showing the u-w plane of a diagonal disparity space according to an embodiment of the present invention.

In the state in which the pixels of left and right images located on the same scan line of stereo images are located in the directions of the u axis and the w axis, respectively, the locations of the pixels of the two images correspond to pixels corresponding to the location of a disparity space image.

The u-w plane of FIG. 4 is geometrically identical to a plane obtained by rotating the u-w plane of FIG. 3 at an angle of 45°. That is, the u-w plane of FIG. 4 can be inferred from the u-w plane of FIG. 3. Therefore, the u-w plane of FIG. 3 and the u-w plane of FIG. 4 have the same information.

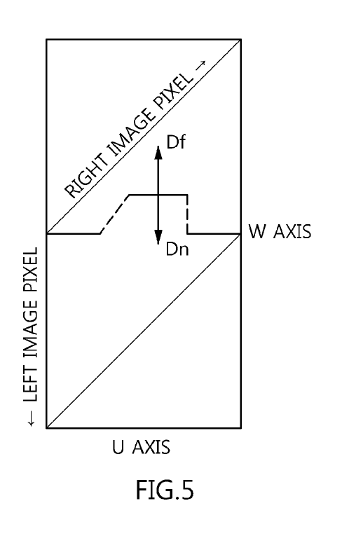

FIG. 5 is a diagram showing the u-w plane of a slanted disparity space according to an embodiment of the present invention.

The u-w plane of FIG. 5 can be inferred from the u-w plane of FIG. 4. Therefore, the u-w plane of FIG. 4 and the u-w plane of FIG. 5 have the same information.

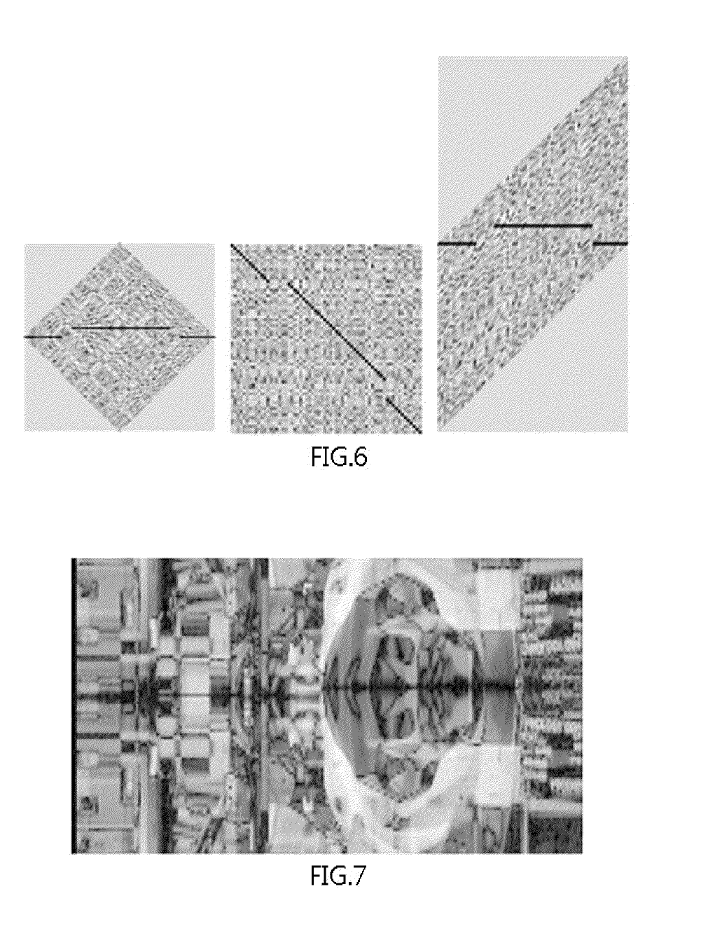

Next, examples of the u-w plane of a disparity space image configured using three types of disparity space configuration described in FIGS. 3 to 5 will be described in detail with reference to FIG. 6.

FIG. 6 is a diagram showing examples of the u-w plane of a disparity space image according to an embodiment of the present invention.

Referring to FIG. 6, bold lines correspond to disparity information, for example, information about disparity curves.

FIG. 6 illustrates ideal examples of disparity information. However, in most cases, disparity information does not obviously appear, unlike FIG. 6. The reason for this is that local variations appearing in luminance distribution of stereo images corresponding to the disparity space are incorporated into the disparity space image generation step S200 of generating the disparity space without change. That is, the dispersion of luminance distribution of one pixel of the stereo image and its neighboring pixels is incorporated into the disparity space image without change.

FIG. 7 is a diagram showing an example of the v-w plane viewed by cutting a classical disparity space image along a direction perpendicular to a u axis according to an embodiment of the present invention. FIG. 8 is a diagram showing an example of the u-w plane viewed by cutting the classical disparity space image along a direction perpendicular to a v axis according to an embodiment of the present invention.

The u-w planes of FIGS. 7 and 8 correspond to portions falling within a preset disparity limit of the entire disparity space image.

In FIGS. 7 and 8, black lines that are indistinctly present along a horizontal direction can be viewed. When all of these lines are connected, a 2-D curved surface, that is, a disparity surface, can be acquired.

In global optimization stereo matching methods including graph-cut optimization, a solution of global optimization is obtained by using the image information shown in FIGS. 7 and 8 without change. However, when disparity information included in a source disparity space image is weak, low reliability results may be derived.

The method and apparatus for processing a disparity space image according to an embodiment of the present invention performs the coherence enhancement processing step S300 and the symmetry enhancement processing step S400 on the disparity space in order to overcome a problem in that it is difficult to configure a disparity surface because the disparity information does not obviously appear in the disparity space image, as described above.

The coherence enhancement processing step S300 is performed for the purpose of reducing the dispersion of luminance distribution of images included in a source disparity space image. A principle in which the dispersion of luminance distribution of the source disparity space image is reduced while disparity information included in the source disparity space image is preserved is applied to this processing step.

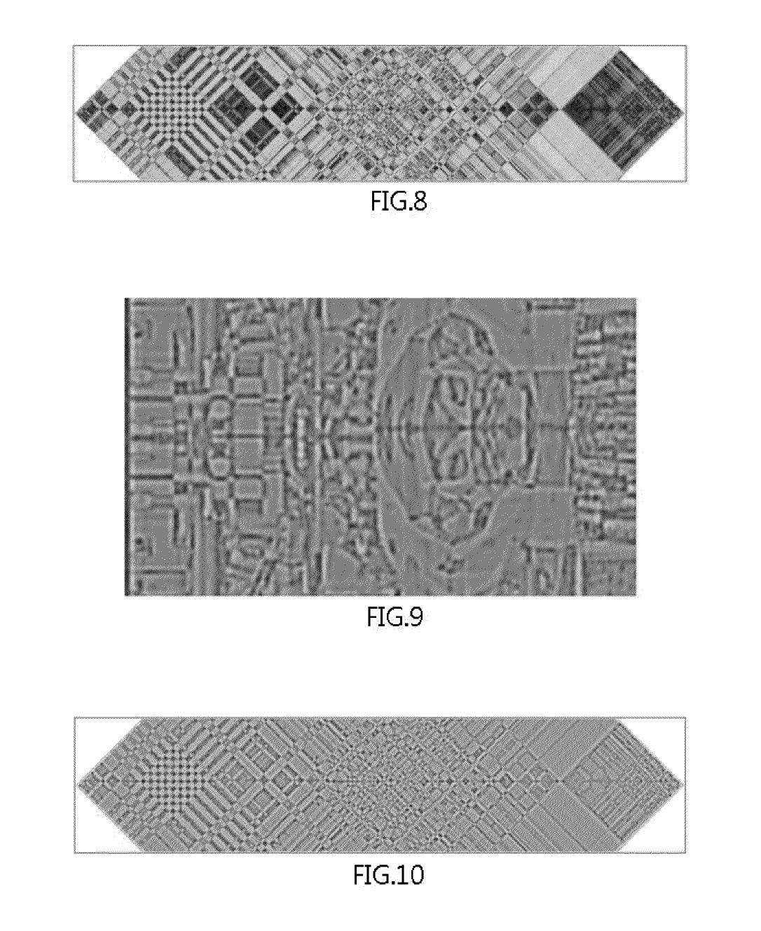

FIGS. 9 and 10 illustrate the results of performing the coherence enhancement processing step on the planes of FIGS. 7 and 8.

The coherence enhancement processing step S300 of deriving the above results is represented by the following Equation (1):

$$C ( {u}_{1} , {v}_{1} , {w}_{1} ) = \frac{1}{{N}_{1}} {\int }_{0}^{{r}_{0}} \frac{D ( r )}{( α + {r}^{n} )} d r - \frac{1}{{N}_{2}} {\int }_{0}^{β {r}_{0}} ( {e}^{- {r}^{m}} D ( r ) ) d r \qquad ( 1 )$$

Equation (1) indicates the application of a function of calculating a weighted mean value of neighboring pixels included in a single Euclidean distance r₀ preset for one center pixel of the disparity space image and a weighted mean value of neighboring pixels included in another Euclidean distance βr₀, and calculating a difference between the two weighted mean values.

In Equation (1), C(u₁, v₁, w₁) becomes a new value for the coherence-enhanced disparity space image output at the coherence enhancement processing step S300, that is, for a center pixel (u₁, v₁, w₁). N₁ and N₂ denote the numbers of pixels corresponding to the procedures of respectively obtaining values in a first term and a second term on the right side of Equation (1). D(r) denotes the value of a pixel currently being calculated. Each of α, β, n, m, and r₀ is a preset constant. α denotes a value falling within the range of more than 0.0, β denotes a value falling within the range of not less than 1.0, n denotes a value falling within the range of more than 0.0, an m denotes a value falling within the range of more than 0.0. The case of n or m being 1 corresponds to a typical Euclidean distance, but the value of n or m is not limited to 1. The values of n and m may be identical, but are not necessarily limited to the identical value. Each of α, β, n, m, and r₀ may be a constant value which is not more than 100.0.

r denotes a Euclidean distance from the center pixel to the pixel currently being calculated, and is represented by the following Equation (2). In Equation (2), each of u, v, and w required to determine the value of r is an integer that is not less than 0. The maximum range of r is r₀, and r₀ is a value falling within the range of not less than 1.0.

r²=u²+v²+w² (2)

The first term in Equation 1 means that a weight set to be decreased in inverse proportion to the distance r from the center pixel (u₁, v₁, w₁) in the disparity space image is multiplied by D(r) that is the value of the calculation target pixel, and resulting values are summed over the entire calculation range. In this case, the integral sign means that values of

$$\frac{D ( r )}{( α + {r}^{n} )}$$

are calculated for all pixels of the source disparity space image included in the Euclidean distance r₀ around the center pixel, and are then summed. The second term means that a weight set to be exponentially decreased according to the distance r from the same center pixel (u₁, v₁, w₁) is multiplied by D(r) that is the value of the calculation target pixel, and the results of multiplication are summed over the entire calculation range. In this case, the integral sign means that values of e^{-r}^{^{m}}D(r) are calculated for all pixels of the source disparity space image included in the Euclidean distance r₀ around the center pixel, and are then summed.

Equation (1) means that a difference between the results of calculation in the first and second terms is output as a value C(u₁, v₁, w₁) that is the value of the center pixel of the coherence-enhanced disparity space image. The center pixel (u₁, v₁, w₁) may be any of all pixels included in the disparity space shown in FIG. 2, but calculation is not necessarily performed on all the pixels. The spatial range of the center pixel can be limited to a minimum range in which a predicted disparity limit or a calculation range for symmetry enhancement processing is taken into consideration.

The range of application of the integral signs used in the first and second terms in the procedure of calculating Equation (1) is limited to the range of realistically present pixels. That is, even if the distance to the calculation target pixel falls within the range of r₀ when the coordinates of the center pixel are (0, 0, 0), and the coordinates of the calculation target pixel are (−1, 0, 0), calculation is not performed on the pixel (−1, 0, 0) that cannot be realistically present.

The results of the calculation of the first and second terms in Equation (1) have the effect of reducing sudden variations in the luminance distribution of images together with the effect of reducing noise pixels. However, since weights corresponding to distances are not identical, the effects appear differently in the two terms. The overall effects based on Equation (1) can be adjusted using the values of α and β, which are preferably set such that the effect of reducing the dispersion of luminance values of the entire coherence-enhanced disparity space image can be achieved. That is, in the preferred settings in Equation (1), α can be interpreted as a constant (that is, a zeroing factor) that causes the sum of luminance values to be approximate to “0” when the luminance values of all pixels of the coherence-enhanced disparity space image obtained at the coherence enhancement processing step S300 are summed. Further, β can be interpreted as a constant (that is, a blurring factor) that determines how the finally generated coherence-enhanced disparity space image is to be blurred. Once α and β are suitably selected, information indicative of the location of a disparity surface can be maintained while the dispersion of luminance distribution of the images included in the disparity space is decreased, as shown in FIG. 9.

Next, the present invention performs the symmetry enhancement processing step S400 on the source disparity space image, or the coherence-enhanced disparity space image on which the coherence enhancement processing step S300 has been completed.

The symmetry enhancement processing step S400 is performed for the purpose of strengthening the neighboring information of true matching points by means of a kind of similarity emphasis processing that uses the inherent characteristics of the disparity space image.

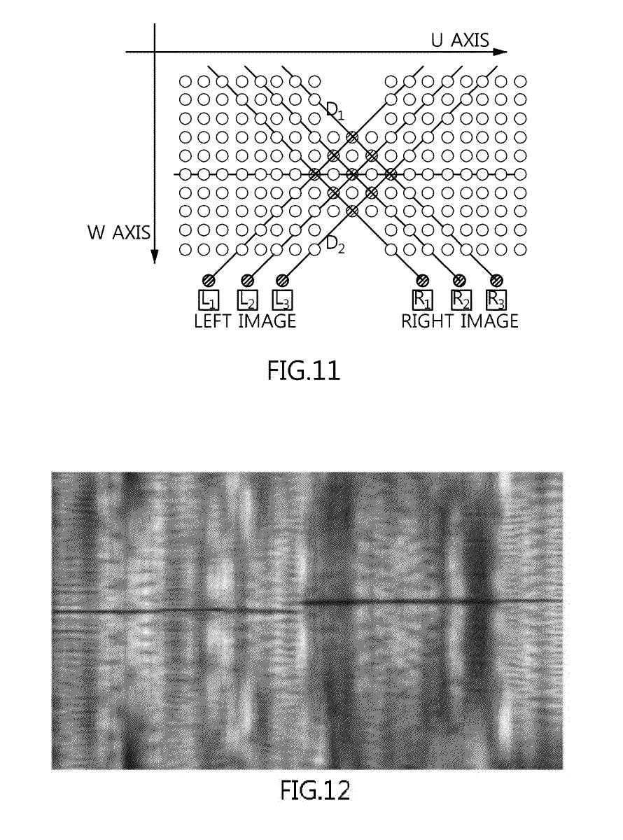

The symmetry enhancement processing step S400 will be described in detail below with reference to FIG. 11.

FIG. 11 is a diagram showing the symmetry enhancement processing step S400 according to an embodiment of the present invention.

First, the symmetry enhancement processing step S400 can be described based on the “u-w plane” shown in FIG. 11.

Referring to FIG. 11, the values of pixels in the u-w plane are determined using the computation of the similarity between pixels included in the specific scan line of a left image and a right image, as in the case of the description regarding the disparity space of FIG. 3. In a generalized disparity space, since pixels included in the specific scan line of the left image and the right image do not exactly correspond to the locations of the pixels of the disparity space, similarity corresponding to the locations of the pixels of the generalized disparity space is computed using interpolation.

In FIG. 11, when I(L₁), I(L₂), and I(L₃) on the specific scan line are the luminance values of pixels in the left image and I(R₁), I(R₂), and I(R₃) are the luminance values of pixels in the right image, I(D₁) that is the value of a pixel D₁ present at the intersection of lines L₁ and R₃ is calculated using the similarity between I(L₁) and I(R₃). Further, I(D₂) that is the value of a pixel D₂ present at the intersection of lines L₃ and R₁ is calculated using similarity between I(L₃) and I(R₁). When the squared difference between the two pixels is used to compute the similarity, I(D₁)=I(L₁)−I(R₃))² and I(D₂)=I(L₃)−I(R₁))² are obtained. In the procedure required to determine the values of the pixels of the source disparity space image, only a squared difference between the values of the two pixels of the stereo images is not necessarily used. A similarity computation means for obtaining the values of pixels of the source disparity space image can be replaced with a similarity computation function or a cost function that is typically used in stereo matching.

The symmetry enhancement processing step S400 is based on the assumption of the reflective symmetry of the disparity space image. The assumption is made such that if a pair of pixels in 2D stereo images are true matching pixels, the luminance values of neighboring pixels arranged at reflective symmetric locations along the w axis about any one pixel of a 3D disparity space image corresponding to the pixel pair have a similar distribution. That is, in FIG. 11, the assumption of reflective symmetry is that if L₂ and R₂ are a pair of pixels corresponding to true matching points, D₁ and D₂ have similar luminance values, a pixel located to the left of D₁ has a luminance value similar to that of a pixel located to the left of D₂, and a pixel located above D₁ has a luminance value similar to that of a pixel located below D₂. Such assumption is to consider that the luminance distribution characteristics of the pixel L₂ and neighboring pixels thereof are similar to those of the pixel R₂ and neighboring pixels thereof. This assumption is based on the smoothness constraint and photometric constraint that are typically used in stereo matching. Therefore, the assumption of the reflective symmetry of the disparity space image becomes a reasonable and proper assumption that is based on the constraints typically used in image matching.

Based on the assumption of the reflective symmetry of the disparity space image, the symmetry enhancement processing step S400 of improving the similarity between D₁ and D₂ arranged at vertically symmetrical locations in the u-w plane according to an embodiment of the present invention can be used. Even for the neighboring pixels of the true matching points of the generalized disparity space, the assumption of reflective symmetry of the disparity space image is established depending on the smoothness constraint and photometric constraint that are typically used in stereo matching, so that the symmetry enhancement processing step S400 identical to the above step S400 can be used.

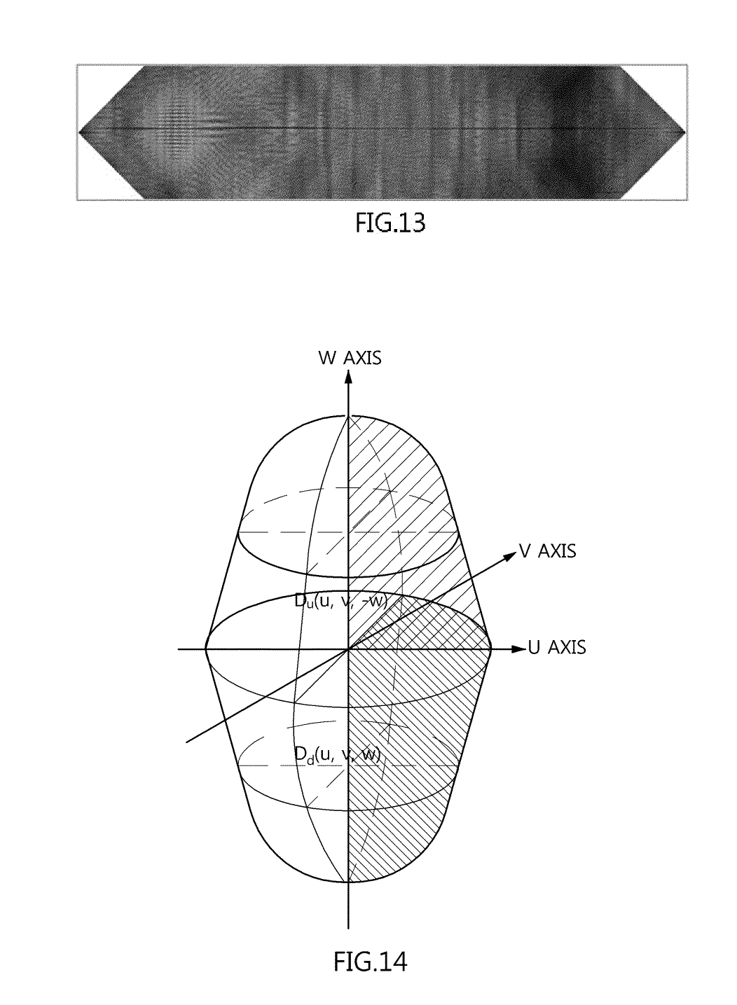

FIGS. 12 and 13 illustrate the results of performing the symmetry enhancement processing step S400 on the results of FIGS. 9 and 10.

Comparing FIGS. 7 and 12 with each other, black lines that are indistinctly present along a horizontal direction in FIG. 7, that is, pixels corresponding to candidates for true matching points, appear relatively distinctly in FIG. 12. This difference can also be seen even by comparison between FIGS. 8 and 13.

The dispersion of luminance values of images in FIG. 7 was greatly decreased in the results of performing the coherence enhancement processing step S300, that is, in FIG. 9. Further, it can be seen that the contrast between pixels corresponding to candidates for true matching points and their neighboring pixels is improved and viewed while the dispersion of luminance values of the image is maintained at a low level in the results of performing the symmetry enhancement processing on step S400 on the plane of FIG. 9, that is, in FIG. 12. This improvement of the contrast appears even in the comparison between FIGS. 7 and 11.

One embodiment of the symmetry enhancement processing step S400 for deriving the above results is given by the following Equation (3) or (4). Equation (3) indicates an embodiment for emphasizing the reflective symmetry of the source disparity space image, and corresponds to the case of performing the symmetry enhancement processing step S400 using the sum of squared differences between the values of pixels arranged at reflective symmetric locations along the w axis. Equation (4) indicates an embodiment for emphasizing reflective symmetry in the coherence-enhanced disparity space image on which the coherence enhancement processing step S300 has been completed, and corresponds to the case of performing the symmetry enhancement processing step S400 using the sum of squared differences between the values of pixels arranged at reflective symmetric locations along the w axis.

S_{D}(u₁,v₁,w₁)=∫∫∫_{0,0,0}^{u}^{₀}^{,v}^{₀}^{,w}^{₀}(Dᵤ(u,v,−w)−D_{d}(u,v,w))²dudvdw (3)

S_{C}(u₁,v₁,w₁)=∫∫∫_{0,0,0}^{u}^{₀}^{,v}^{₀}^{,w}^{₀}(Cᵤ(u,v,−w)−C_{d}(u,v,w))²dudvdw (4)

Referring to Equation (3), S_{D}(u₁, v₁, w₁) denotes a value obtained by performing symmetry enhancement processing for computing the similarities of neighboring pixels using symmetry along the w axis about one center pixel (u₁, v₁, w₁) of the source disparity space image. Dᵤ(u, v, −w) denotes the value of a pixel of the source disparity space image having a relative location of (u, v, −w) about the one center pixel (u₁, v₁, w₁) of the source disparity space image, and D_{d}(u, v, w) denotes the value of a pixel of the source disparity space image having a relative location of (u, v, w). That is, Dᵤ and D_{d} denote the values of a pair of pixels arranged at reflective symmetric locations on the upper and lower sides of the w axis about the center pixel. (u₀, v₀, w₀) denotes the maximum range of (u, v, w).

Equation (3) means the operation of calculating squared differences between the values of the pixels arranged at the reflective symmetric locations along the w axis about the center pixel (u₁, v₁, w₁), and summing the squared differences over the entire computation range. In this case, the integral sign means that values of (Dᵤ(u, v, −w)−D_{d}(u, v, w))² are calculated for all pixels of the source disparity space image falling within the range of (u₀, v₀, w₀) around the center pixel and are then summed.

Referring to Equation (4), S_{C}(u₁, v₁, w₁) denotes a value obtained by performing symmetry enhancement processing for computing the similarities of neighboring pixels using the symmetry along the w axis about the center pixel (u₁, v₁, w₁) of the coherence-enhanced disparity space image. Cᵤ and C_{d} denote the values of a pair of pixels arranged at reflective symmetric locations on the upper and lower sides of the w axis about the center pixel in the coherence-enhanced disparity space image on which the coherence enhancement processing step S300 has been completed. (u₀, v₀, w₀) denotes the maximum range of (u, v, w).

The integral sign in Equation (4) means that the values of (Cᵤ(u, v, −w)−C_{d}(u, v, w))² are calculated for all pixels of the coherence-enhanced disparity space image falling within the range of (u₀, v₀, w₀) about the center pixel (u₁, v₁, w₁) and are the summed.

Equations (3) and (4) denote the processing procedure of computing similarities using the sum of squared differences between the values of the pixels arranged at the reflective symmetric locations in the vertical direction of the w axis about the center pixel (u₁, v₁, w₁). In this way, although the symmetry enhancement processing step S400 according to the embodiment of the present invention has been described as computing similarities using the sum of squared differences, the present invention is not limited thereto.

According to the assumption related to the reflective symmetry of the disparity space image, pixels symmetrically arranged above and below one center pixel along the w axis have the characteristics of a similar luminance distribution. Therefore, the symmetry enhancement processing step S400 may be configured using a typical similarity computation function in stereo matching instead of the sum of squared differences. Examples of the typical similarity computation function may correspond to various functions, such as a computation function for the sum of absolute differences, a cross correlation computation function, a computation function for the sum of absolute differences to the mean value of a plurality of pixels, an adaptive support weight computation function, and a similarity computation function using a histogram.

In Equations (3) and (4), the spatial range in which the symmetry enhancement processing step S400 is performed is defined by (u₀, v₀, w₀). This spatial range will be described in detail with reference to FIG. 14.

FIG. 14 is a diagram showing a spatial range in which the symmetry enhancement processing step S400 is performed according to an embodiment of the present invention.

Referring to FIG. 14, the spatial range in which the symmetry enhancement processing step S400 is performed is defined by a 3D space area having symmetry along the w axis. Here, the 3D space area can be defined as a 3D area defined by a function having symmetry along the w axis while having a limited volume, such as an ellipsoid, an elliptical cone, a hexahedron, and a sphere, as well as an elliptic paraboloid, as given by the following Equation (5):

$${( \frac{{u}_{1}}{{u}_{0}} )}^{2} + {( \frac{{v}_{1}}{{v}_{0}} )}^{2} + {( \frac{{w}_{1}}{{w}_{0}} )}^{2} = 1 \text{:} {ellipsoid \\ ( \frac{{u}_{1}}{{u}_{0}} )}^{2} + {( \frac{{v}_{1}}{{v}_{0}} )}^{2} = \frac{{w}_{1}}{{w}_{0}} \text{:} elliptic {paraboloid \\ ( \frac{{u}_{1}}{{u}_{0}} )}^{2} + {( \frac{{v}_{1}}{{v}_{0}} )}^{2} = {( \frac{{w}_{1}}{{w}_{0}} )}^{2} \text{:} elliptical cone \qquad ( 5 )$$

In the u-w plane, the range of computation corresponding to the symmetry enhancement processing step S400 does not need to have a symmetrical shape along each of the u axis and the v axis. In FIG. 14, the computation area can be defined only for one quadrant in which coordinate values (u, v) are positive values. If the results of applying the symmetry enhancement processing step S400 to individual quadrants are compared, the influence attributable to occlusion can be reduced.

As described above, the equations or drawings used in the coherence enhancement processing step S300 and the symmetry enhancement processing step S400 according to the embodiment of the present invention are described based on the classical 3D disparity space.

The characteristics of data included in disparity spaces corresponding to three types of disparity space configuration are identical and can be mutually transformed. Therefore, the description of the configuration of the present invention made based on the classical 3D disparity space can be applied to a diagonal type and a slanted type, and can also be applied to the generalized disparity space.

When the u-w plane is rotated at an angle of 45° with respect to the v axis in the classical disparity space, the equations and computation procedures of functions that have been described with respect to the classical disparity space can be applied to the diagonal disparity space. Further, the slanted coordinate system can be introduced into the transformation between the u-w plane of the diagonal disparity space and the u-w plane of the slanted disparity space. If the coordinates transform equations based on camera models are applied to the classical 3D disparity space, transformation into the generalized disparity space is possible. Therefore, the equations and calculation procedures of the functions described in relation to the classical 3D disparity space can be transformed into and applied to the generalized disparity space.

Therefore, the equations and calculation procedures of the functions according to the present invention can be transformed into and applied not only to the classical disparity space, but also to other disparity spaces or a generalized disparity space having the same information, or other transformable disparity spaces using a similar method.

The equations and calculation procedures of functions that have been described based on the classical 3D disparity space are applicable to 2D planes. That is, the equations and calculation procedures can be applied to an individual u-w plane corresponding to one pixel of the v axis or an individual v-w plane corresponding to one pixel of the u axis. Further, the equations and calculation procedures can be applied even to the planes of other disparity spaces generated using the transformation of the classical disparity space.

Next, matching points, that is, candidates for true matching points, are extracted from the symmetry-enhanced disparity space image according to an embodiment of the present invention, and a disparity surface can be extracted by connecting locally optimized solutions or globally optimized solutions in the u-w plane on the basis of the results of extraction. Here, a method of obtaining locally optimized solutions or globally optimized solutions is based on the method of generally obtaining optimized solutions.

The method of processing a disparity space image according to the present invention can be implemented as a program and can be stored in various types of computer-readable storage media (Random Access Memory (RAM), Read Only Memory (ROM), Compact Disk-ROM (CD-ROM), a floppy disk, a hard disk, and a magneto-optical disk). Further, the method can be implemented as an electronic circuit or an internal program embedded in a camera, or as an electronic circuit or an internal program that is embedded in an external controller connectable to the camera.

In accordance with the embodiments of the present invention, the method of processing a disparity space image can apply a coherence enhancement processing step and a symmetry enhancement processing step to the disparity space image, thus solving the problems of making it difficult to improve the precision of stereo matching due to the low reliability of disparity information included in the disparity space configured for stereo matching, and strengthening neighboring information around true matching points.

In accordance with the embodiments of the present invention, the coherence enhancement processing step reduces the dispersion of luminance distribution of images included in the disparity space image, thus improving the efficiency of a subsequent step, that is, the symmetry enhancement processing step. Further, in accordance with the embodiments of the present invention, the symmetry enhancement processing step strengthens the contrast of images around true matching points via a kind of image matching emphasis processing using the inherent characteristics of the disparity space, thus improving the efficiency of a surface extraction step that is performed at a subsequent step.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A method of processing a disparity space image, comprising:
capturing stereo images including parallax using at least two cameras;
generating pixels of a source disparity space image based on the stereo images;
generating a symmetry-enhanced disparity space image by performing symmetry enhancement processing on the source disparity space image; and
extracting a disparity surface by connecting at least three matching points in the symmetry-enhanced disparity space image.

2. The method of claim 1, further comprising, before the generating the symmetry-enhanced disparity space image, performing coherence enhancement processing on the disparity space image.

3. The method of claim 2, wherein the performing the coherence enhancement processing is configured to apply a function of calculating a weighted mean value of neighboring pixels included in a single Euclidean distance preset for one center pixel of the source disparity space image and a weighted mean value of neighboring pixels included in another Euclidean distance and then calculating a difference between the two weighted mean values.

4. The method of claim 3, wherein the function of calculating the difference between the two weighted mean values is configured to apply the following Equation (1) to the disparity space image:
$$C ( {u}_{1} , {v}_{1} , {w}_{1} ) = \frac{1}{{N}_{1}} {\int }_{0}^{{r}_{0}} \frac{D ( r )}{( α + {r}^{n} )} d r - \frac{1}{{N}_{2}} {\int }_{0}^{β {r}_{0}} ( {e}^{- {r}^{m}} D ( r ) ) d r \qquad ( 1 )$$
where C(u₁, v₁, w₁) denotes results of the function of calculating a difference between mean values of the neighboring pixels, that is, a new value for a center pixel (u₁, v₁, w₁), α denotes a preset constant having a value falling within a range of more than 0.0, β denotes a preset constant having a value falling within a range of not less than 1.0, n denotes a preset constant having a value falling within a range of more than 0.0, m denotes a preset constant having a value falling within a range of more than 0.0, r denotes a Euclidean distance from the center pixel to a pixel currently being calculated, r₀ denotes a maxim range of r, D(r) denotes a value of a pixel located at the Euclidean distance r from the center pixel, and N₁ and N₂ denote numbers of pixels corresponding to a first term and a second term, respectively, on a right side of Equation (1).

5. The method of claim 1, wherein the generating the symmetry-enhanced disparity space image is configured to apply a function of computing similarities between pixels of the disparity space image arranged at reflective symmetric locations along a vertical direction of a w axis about a center pixel of the source disparity space image.

6. The method of claim 5, wherein the function of computing the similarities between the pixels of the disparity space image is configured to perform computation at locations corresponding to respective pixels of the disparity space image by applying the following Equation (2) to the source disparity space image:
S_{D}(u₁,v₁,w₁)=∫∫∫_{0,0,0}^{u}^{₀}^{,v}^{₀}^{,w}^{₀}(Dᵤ(u,v,−w)−D_{d}(u,v,w))²dudvdw (2)
where S_{D}(u₁, v₁, w₁) denotes results obtained by the function of computing the similarities between the pixels of the disparity space image, that is, a new value for a center pixel (u₁, v₁, w₁), Dᵤ(u, v, −w) denotes a value of a pixel of the source disparity space image at a location of pixel coordinates (u, v, −w) around the center pixel, D_{d}(u, v, w) denotes a value of a pixel of the source disparity space image at a location of pixel coordinates (u, v, w) around the center pixel, and (u₀, v₀, w₀) denotes a maximum range of (u, v, w).

7. The method of claim 2, wherein the generating the symmetry-enhanced disparity space image is configured to apply a function of computing similarities between pixels of the coherence-enhanced disparity space image arranged at reflective symmetric locations along a vertical direction of a w axis about one center pixel of the coherence-enhanced disparity space image on which the coherence enhancement processing has been completed.

8. The method of claim 7, wherein the function of computing the similarities between the pixels of the coherence-enhanced disparity space image is configured to perform computation at locations corresponding to respective pixels of the disparity space image by applying the following Equation (3) to the coherence-enhanced disparity space image on which the coherence enhancement processing has been completed:
S_{C}(u₁,v₁,w₁)=∫∫∫_{0,0,0}^{u}^{₀}^{,v}^{₀}^{,w}^{₀}(Cᵤ(u,v,−w)−C_{d}(u,v,w))²dudvdw (3)
when S_{C}(u₁, v₁, w₁) denotes results obtained by the function of computing the similarities between the pixels of the coherence-enhanced disparity space image, that is, a new value for a center pixel (u₁, v₁, w₁), Cᵤ(u, v, −w) denotes a value of a pixel of the coherence-enhanced disparity space image at a location of pixel coordinates (u, v, −w) about the center pixel, C_{d}(u, v, w) denotes a value of a pixel of the coherence-enhanced disparity space image at a location of pixel coordinates (u, v, w) around the center pixel, and (u₀, v₀, w₀) denotes a maximum range of (u, v, w).
